(19) United States
(12) Patent Application Publication
(10) Pub. No.: US 2015/0245963 A1
(43) Pub. Date: Sep. 3, 2015

(54) FOLDABLE WHEELCHAIR FRAME INCLUDING A SELF LOCKING DEVICE

(71) Applicants: Aurelie Lauret, Lignieres de Touraine (FR); Christian Jouannet, Fondettes (FR); Wifrid Da Cunha, Druye (FR); Jean-Michel Roncin, Tours (FR)

(72) Inventors: Aurelie Lauret, Lignieres de Touraine (FR); Christian Jouannet, Fondettes (FR); Wifrid Da Cunha, Druye (FR); Jean-Michel Roncin, Tours (FR)

(73) Assignee: Invacare International Sarl, Gland (CH)

(21) Appl. No.: 14/418,091

(22) PCT Filed: Jul. 31, 2012
(86) PCT No.: PCT/IB12/53910

§ 371 Date: Apr. 15, 2015

(51) Int. Cl. A61G 5/08

(52) U.S. Cl. CPC A61G 5/08; A61G 2005/0816; A61G 2005/0883

(57) ABSTRACT

The present invention relates to a foldable wheelchair frame (10) comprising two side frame components (11a, 11b), respectively a left and a right side frame components, each mounting front and rear wheels (12a, 13a; 12b, 13b), said side frame components (11a, 11b) being connected together for relative folding movement between an erected position and a folded position by foldable link means (20) extending between said two side frame components (11a, 1b), wherein the foldable link means (20) comprises at least one central strut (21) disposed between said two side frame components (11a, 11b) and connected to each side frame component (11a, 11b) by at least two connecting arms, respectively a first left and a second left connecting arms (22a, 23a; 22′a, 23′a) connected to the left side frame component (11a) and a first right and a second right connecting arms (22b, 23b; 22′b, 23′b) connected to the right side frame component (11b), each of said connecting arms being pivotally connected at one end to one of said side frames (11a, 11b) and at one other end to said central strut (21) such that said side frame components (11a, 11b) move closer to each other and said central strut (21) moves along a longitudinal direction when the wheelchair frame moves from its erected position to its folded position, and wherein said central strut comprises at least one locking element (24, 25), said locking element defining at least one left abutment (26a), respectively one right abutment (26b), against which abuts a left locking pin (27a), respectively a right locking pin (27b), protruding from the lower or upper face (28, 28′) of one of said first left and said second left, respectively said first right and said second right, connecting arms in a vertical direction, when the wheelchair is in its erected position.

### TECHNICAL FIELD

The present invention relates in general to foldable wheelchairs. More particularly, the present invention relates to a foldable wheelchair frame including a self locking device.

### PRIOR ART AND THE PROBLEM UNDERLYING THE INVENTION

Foldable wheelchairs have been known for some time, and the advantages are numerous with respect to managing the wheelchair when it is not in use, or for transportation of the wheelchair.

Traditionally, foldable wheelchairs include frames provided with locking systems. These locking systems are designed to lock the frame in a fully erected position corresponding to the position of use of the wheelchair. However, the problem with such frames is often the difficulty for the user to easily access to the locking systems when he wants to move the wheelchair frame from this fully erected position to a fully folded position in which the wheelchair can be easily transported. Thus, a first objective of the present invention is to provide a foldable wheelchair frame which can be folded without requiring the handling of locking systems.

A second objective of the present invention is to provide a foldable wheelchair frame that can be easily and quickly folded and erected.

A third objective of the present invention is to provide a foldable wheelchair frame that can be locked both in a folded position and in an erected position.

### SUMMARY OF INVENTION

In an aspect, the present invention provides a foldable wheelchair frame comprising two side frame components, respectively a left and a right side frame components, each mounting front and rear wheels, said side frame components being connected together for relative folding movement between an erected position and a folded position by foldable link means extending between said two side frame components, wherein the foldable link means comprises at least one central strut disposed between said two side frame components and connected to each side frame component by at least two connecting arms, respectively a first left and a second left connecting arms connected to the left side frame component and a first right and a second right connecting arms connected to the right side frame component, each of said connecting arms being pivotally connected at one end to one of said side frames and at one other end to said central strut such that said side frame components move closer to each other and said central strut moves along a longitudinal direction when the wheelchair frame moves from its erected position to its folded position, and wherein said central strut comprises at least one locking element, said locking element defining at least one left abutment, respectively one right abutment, against which abuts a left locking pin, respectively a right locking pin, protruding from the lower or upper face of one of said first left and said second left, respectively said first right and said second right, connecting arms in a vertical direction, when the wheelchair is in its erected position and wherein the pivot axes around which are pivotally connected the first left and right, respectively the second left and right, pairs of connecting arms to the central strut are positioned, in the erected position of the wheelchair frame, frontward relative to the vertical plane going through the pivot axes around which are pivotally connected said pairs of connecting arms to the left and right side frame components, thus securing the wheelchair frame in its erected position.

Further aspects and preferred embodiments are provided in the appended claims.

### BRIEF DESCRIPTION OF THE DRAWINGS

The wheelchair frame of the present invention will be described in further detail further below, when useful with reference to the attached drawings, which show an exemplary wheelchair frame according to the invention.

FIG. 1 is a perspective view of a wheelchair including a wheelchair frame according to the present invention, said wheelchair being in its position of use.

FIG. 2a is a perspective view of a wheelchair frame according to a first embodiment of the present invention, when locked in its erected position.

FIG. 2b is a view from below of the wheelchair frame as shown in FIG. 2a.

FIG. 2c is a perspective view of the wheelchair frame of FIG. 2a, when locked in its folded position.

FIG. 2d is a view from below of the wheelchair frame as shown in FIG. 2c.

FIG. 2e is a side view of the wheelchair frame of FIG. 2a.

FIG. 3a is a perspective view of a wheelchair frame according to a second embodiment of the present invention, when locked in its erected position

FIG. 3b is a view from below of the wheelchair frame as shown in FIG. 3a.

FIG. 3c is a perspective view of the wheelchair frame of FIG. 3a, when locked in its folded position.

FIG. 3d is a view from below of the wheelchair frame as shown in FIG. 3c.

FIG. 4a is a perspective view of a wheelchair frame according to a third embodiment of the present invention, when locked in its erected position

FIG. 4b is a view from below of the wheelchair frame as shown in FIG. 4a.

FIG. 4c is a perspective view of the wheelchair frame of FIG. 4a, when locked in its folded position.

FIG. 4d is a view from below of the wheelchair frame as shown in FIG. 4c.

FIG. 5 is an enlarged view of the detail A identified in FIG. 2b.

### DETAILED DESCRIPTION OF THE PREFERRED EMBODIMENTS

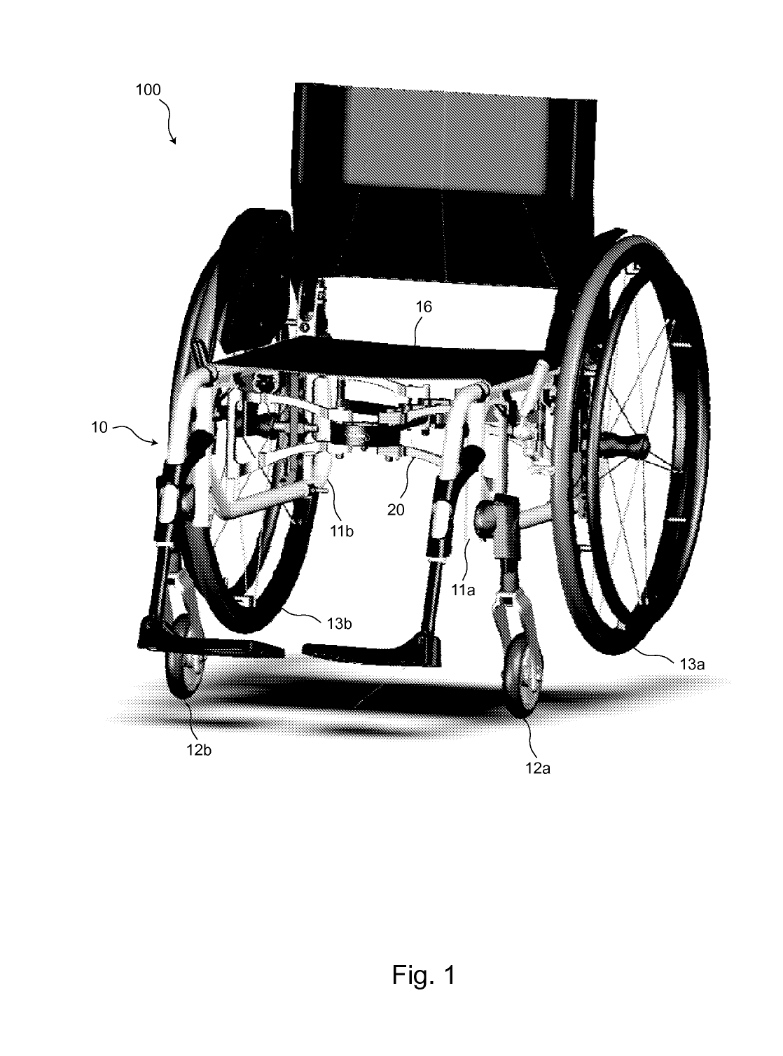

For the purpose of the present specification, situations and directions of elements of the wheelchair of the present invention are determined by the perspective of a user seated in the wheelchair. Accordingly, the left side of the wheelchair corresponds to the right side of FIG. 1. The situations or directions “up” or “top” and “down” or “bottom”, “rear” or “back” and “front”, “behind” and “in front”, “upper” and “lower”, “lateral” and “central” follow the same rule. A longitudinal direction corresponds to a back-to-front direction and a lateral direction corresponds to a left-to-right direction. The horizontal corresponds to the plane tangential to the rear and front wheels and positioned under said wheels when the wheelchair is its normal position of use. A horizontal plane corresponds to a plane parallel to the horizontal. The vertical, or a vertical plane, corresponds to a plane perpendicular to the horizontal.

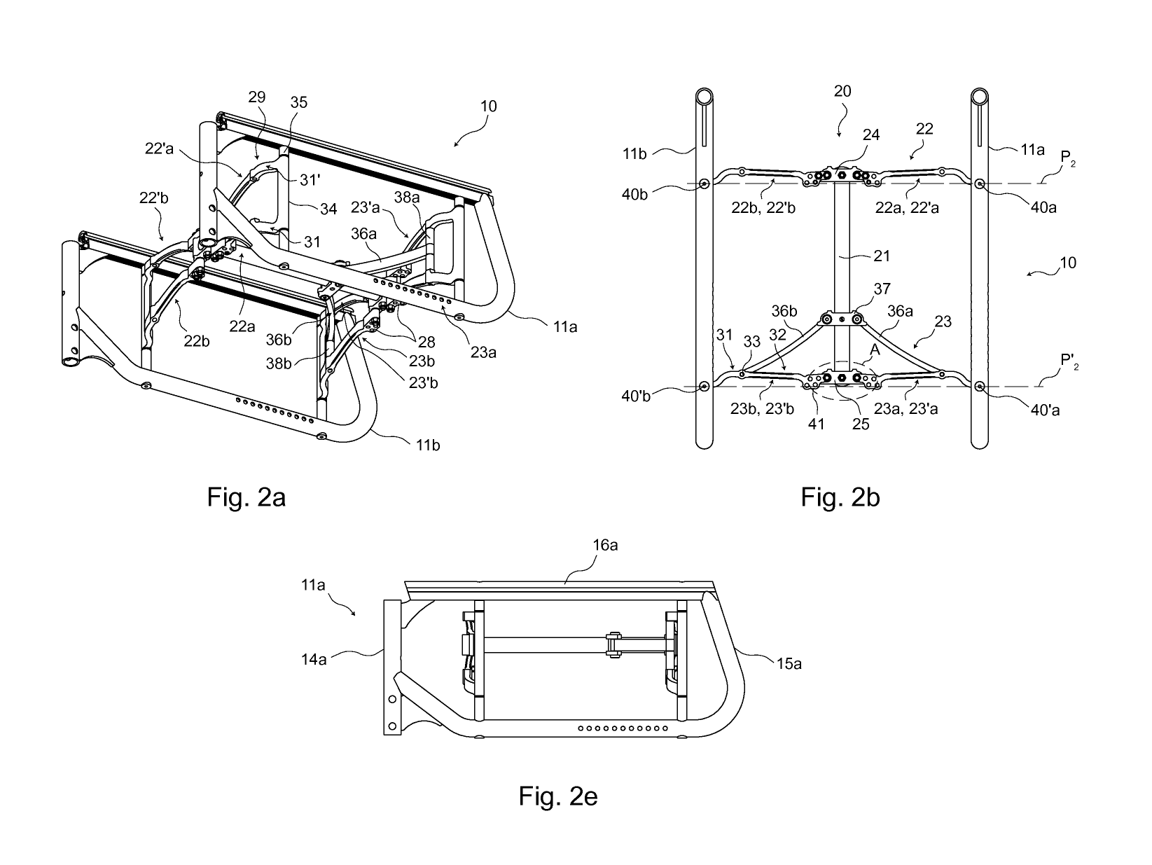

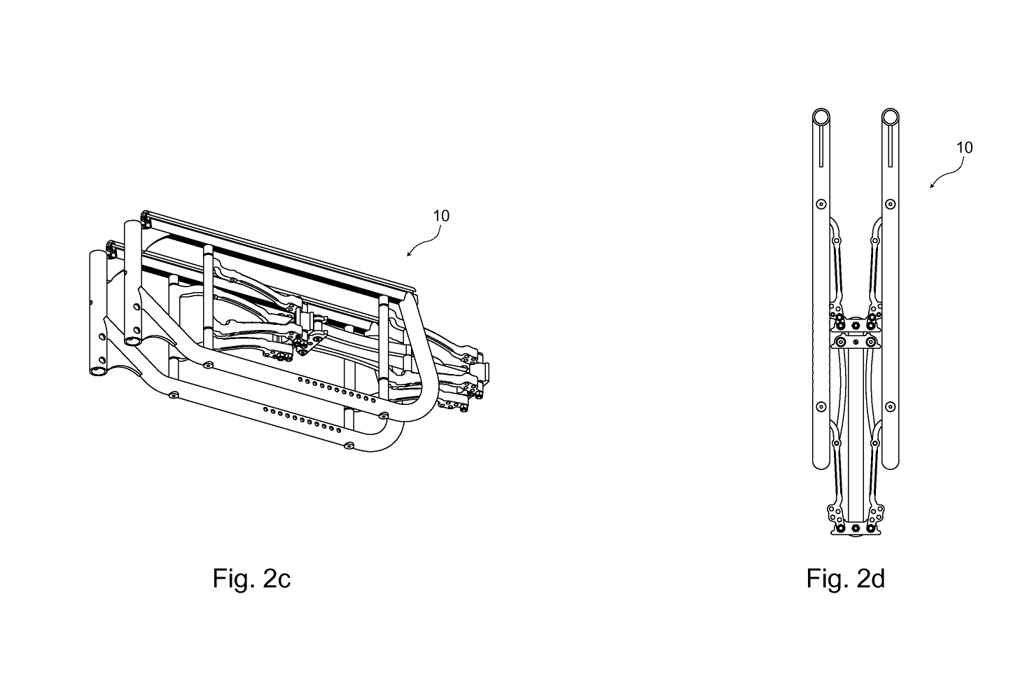

FIG. 1 shows a foldable wheelchair according to the present invention. This wheelchair may be a dismountable wheelchair, meaning that at least a part of the wheelchair can be reversibly removed from the wheelchair. In this way, it is possible to remove at least one part, for example for the purpose of repairing the part or in order to arrange the wheelchair in a more space-saving manner, for example for storage and/or transport of the wheelchair. Thus, any one selected from the seat, the backrest, the armrest, the legrest may be demountable and remountable. The wheelchair 100 of FIG. 1 includes a frame 10 with front and rear wheels 12a, 13a and 12b, 13b, respectively, extending downwardly therefrom for engaging the ground. The frame 10 includes a left side component 11a and a right side component 11b connected together via a foldable link means 20. With reference to FIG. 2e, the left side component 11a comprises an upright 14a, an L-shaped bar 15a and a horizontal crossbar 16a extending therebetween. The right side component 11b is identical to the left side component 11a. A seating structure 16 extends between the left and the right side components 11a, 11b. The frame 10 is preferably made up of a lightweight high-strength material, such as aluminium.

As shown in FIGS. 2a and 2b, the foldable link means 20 can be deployed into an extended position to maintain the wheelchair frame 10 into an erected position and, as shown in FIGS. 2c and 2d, can be collapsed to bring the left and right side components 11a and 11b into close proximity, thus maintaining the wheelchair frame 10 into a folded position.

In the embodiment shown, the foldable link means 20 consists in an articulated structure comprising a central strut 21 extending in a longitudinal direction and disposed between and parallel to the left and right side components 11a, 11b, said central strut being connected thereto by a first pair of front left and right wings 22 and by a second pair of rear left and right wings 23, said first pair and said second pair being longitudinally spaced-apart. Each wing 22 or 23 consists in a pair of connecting arms, respectively a first, or front, lower and upper left connecting arms 22a, 22′a and a second, or rear, lower and upper left connecting arms 23a, 23′a connected to the left side frame component 11a and a first, or front, lower and upper right connecting arms 22b, 22′b and a second, or rear, lower and upper right connecting arms 23b, 23′b connected to the right side frame component 11b, each of said connecting arms being pivotally connected at one proximal end to the left or right side frame components 11a, 11b and at one distal end to the central strut 21. Thus configured, the foldable link means 20 permits to move the wheelchair frame 10 from the erected position illustrated in FIGS. 2a and 2b, in which the left and right side frame components 11a, 11b are laterally spaced-apart, to the folded position illustrated in FIGS. 2c and 2d, in which the left and right side frame components 11a, 11b are in close proximity. During the folding operation of the wheelchair frame, the central strut 21 moves along a longitudinal direction, rearward, as illustrated in the embodiment shown, or frontward, in a further embodiment not shown, relative to the left and right side frame components 11a, 11b.

Furthermore, to easily fold the wheelchair frame, each connecting arm may advantageously be articulated around a pivot axle 33 and comprises a proximal part 31 pivotally connected to the left or right side frame component 11a, 11b and a distal part 32 pivotally connected to the central strut 21, said proximal part and said distal part being pivotally connected together around said vertical axle. In the specific embodiment shown, the proximal parts of the first lower and upper left, and, respectively, of the second lower and upper left, and, respectively, of the first lower and upper right, and, respectively, of the second lower and upper right, connecting arms are linked by a vertical flange 34 so as to form a single U-shape piece 29, said U-shape piece being pivotally connected to a vertical crosspiece 35 extending between the L-shaped bar 15a and the horizontal crossbar 16a of the left or right side frame component 11a, 11b.

Furthermore, to maintain a symmetrical position of the left and right side frame components 11a, 11b relative to the central strut 21 during the folding operation of the wheelchair frame 10, the foldable link means 20 comprises also a guiding element 37 slidably movable along the central strut 21, said guiding element being linked to the second pair of rear left and right wings 23 through a left lever arm 36a and a right lever arm 36b, said left lever arm 36a, respectively said right lever arm 36b, being pivotally connected at one end to said guiding element 37 and at the other end to a vertical crossbar 38a, respectively 38b, extending between the second lower and upper left connecting arms 23a, 23′a, respectively the second lower and upper right connecting arms 23b, 23′b. In the embodiment shown, the vertical crossbar 38a, respectively 38b, is advantageously aligned with the vertical axle 33 around which is pivotally connected the proximal part 31 and the distal part 32 of the second lower and upper left connecting arms 23a, 23′a, respectively of the second lower and upper right connecting arms 23b, 23′b.

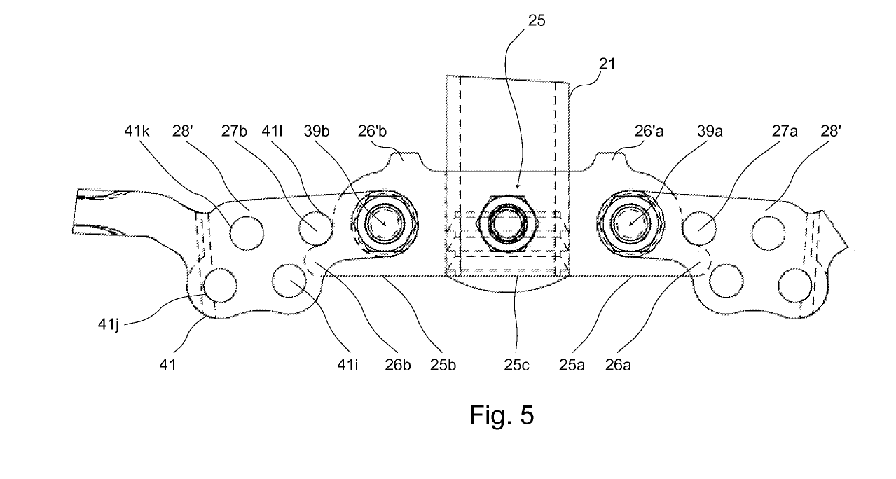

The foldable link means 20 further comprises locking means so as to lock the wheelchair frame 10 in its erected and folded positions. In the embodiment shown, such locking means consist in a front locking element 24 and in a rear locking element 25 fixedly connected at both ends of the central strut 21 respectively. In a further embodiment of the invention (not shown), said front and rear locking elements 24, 25 may also be integral with the central strut 21. As illustrated in detail in FIG. 5, the rear locking element 25 comprises a left end portion 25a and a right end portion 25b, said left and right end portions 25a, 25b being linked by a central portion 25c. The left end portion 25a, respectively the right end portion 25b, has approximately a quarter-cylindrical form and the central portion 25c defines approximately a parallelepiped. The axis of the quarter-cylindrical form is advantageously aligned with the pivot axis 39a, for the left portion 25a, or the pivot axis 39b, for the right portion 25b, around which are pivotally connected the second lower and upper left connecting arms 23a, 23′a, respectively the second lower and upper right connecting arms 23b, 23′b, to the central strut 21. Furthermore, the left end portion 25a, respectively the right end portion 25b, comprises two radially protruding parts 26a, 26′a, respectively 26b, 26′b, said protruding parts being angularly spaced-apart along the periphery of the locking element 25 and defining a first left and a second left, respectively a first right and a second right, abutments against which abuts a left locking pin 27a, respectively a right locking pin 27b, extending vertically between and fixedly connected to the second lower and upper left connecting arms 23a, 23′a, respectively the second lower and upper right connecting arms 23b, 23′b. Thus, in the erected position of the wheelchair frame 10, the left and right locking pins 27a, 27b abut respectively against the first left and right abutments 26a, 26b and, in the folded position of the wheelchair frame 10, the left and right locking pins 27a, 27b abut respectively against the second left and right abutments 26′a, 26′b. The front locking element 24 is identical to the rear locking element 25.

Furthermore, so as to secure the wheelchair frame in its erected position, the pivot axes 39a and 39b may advantageously be positioned, in the erected position of the wheelchair frame, frontward relative to the vertical plane P2, respectively P′2, going through the pivot axes 40a and 40b, respectively 40′a and 40′b, around which are pivotally connected the front left and right wings 22, respectively the rear left and right wings 23, to the left and right side frame components 11a and 11b. Indeed, during the normal use of the wheelchair, the weight of the user exerts a downward oriented strength on the central portion of the flexible seat 16, which generates a deformation of the seat. Thus configured, the seat 16 exerts an internally laterally oriented strength on the side frame components 11a, 11b, which favours the movement of the wheelchair frame 10 from its erected position to its folded position. However, to prevent or at least limit the risk of an accidental folding of the wheelchair frame in its erected position, the invention proposes to position the pivot axes 39a and 39b frontward relative to an unstable balance position in which the efforts required to fold the wheelchair frame are substantially equal to the efforts exerted by the seat. Technical studies have shown that this unstable balance position correspond the specific configuration of the wheelchair frame in which the pivot axes 39a and 39b are positioned in the plane P2 or P′2. Thus, in positioning the pivot axes 39a and 39b frontward relative to said plane P2 or P′2, the efforts exerted by the seat can not generate a folding of the wheelchair frame in its erected position.

Furthermore, so as to allow small changes in the configuration of the wheelchair frame in its erected and/or folded position, in particular so as to modify the position of the locking pins 27a and 27b, a distal end 41 of each connecting arm is advantageously provided with a plurality of vertical through-holes 41i, 41j, 41k, 41l, two of said through-holes, respectively the through-holes 41k and 41l, being adapted to receive the left or the right locking pins 26a, 26b, 26′a or 26′b.

Furthermore, so as to secure the wheelchair frame in its erected or folded position, the foldable link means 20 may advantageously comprise safety means adapted to maintain the left and/or right locking pin 27a, 27b in contact with the corresponding abutments of the locking element 24 or 25.

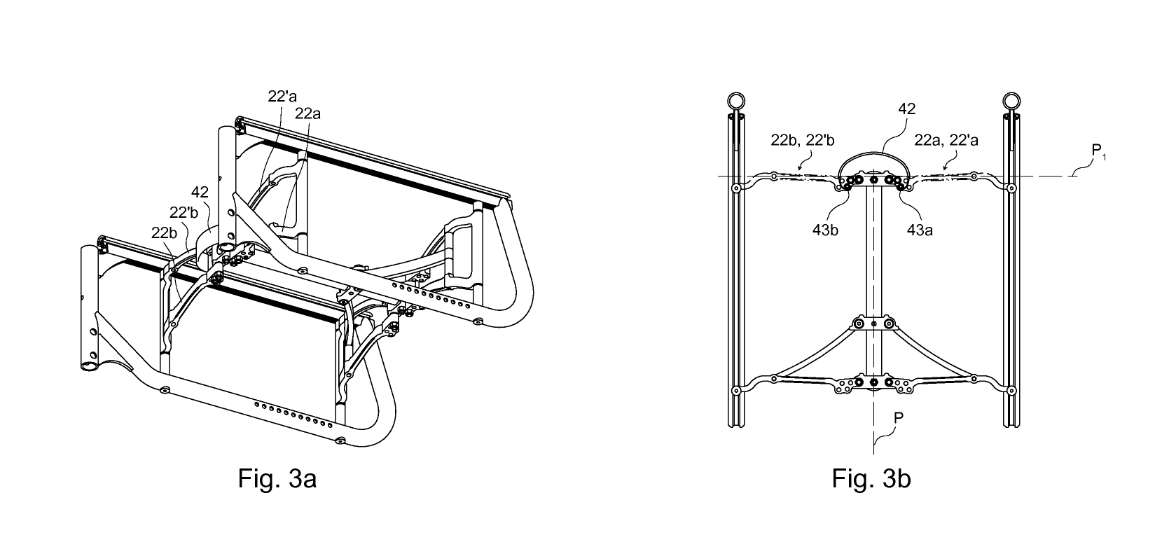

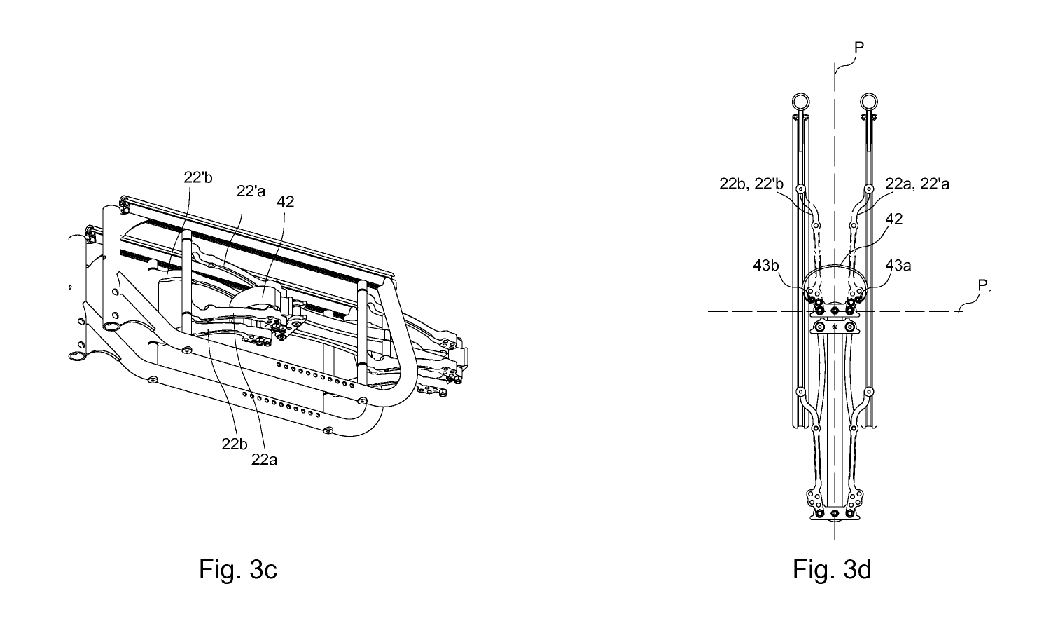

In the embodiment illustrated in FIGS. 3a to 3d, the safety means consists in an arc-shaped leaf spring 42 attached at one end to a left anchoring rod 43a extending between and fixedly connected to the first lower and upper left connecting arms 22a, 22′a and at the other end to a right anchoring rod 43b extending between and fixedly connected to the first lower and upper right connecting arms 22b, 22′b. The left anchoring rod 43a, respectively the right anchoring rod 43b, may advantageously be received in one of the through-holes 41i and 41j provided in the distal end 41 of the first lower and upper left connecting arms 22a, 22′a, respectively the first lower and upper right connecting arms 22b, 22′b. In the preferred embodiment shown, said first lower and upper left connecting arms 22a, 22′a and said first lower and upper right connecting arms 22b, 22′b may advantageously be sensitively symmetrical with regard to the vertical plane P that goes through the center of the arc defined by the leaf spring 42, both into the erected and folded positions of the wheelchair frame 10. Indeed, such a configuration confers a great stability to the wheelchair frame 10. Furthermore, the leaf spring 42 may advantageously be configured so that the direction of the torque generated by the leaf spring 42 changes according to the position of the left and right anchoring rods 43a, 43b relative to the vertical plane P1 going through the pivot axes 39a, 39b around which are pivotally connected said first lower and upper left and right connecting arms 22a, 22′a, 22b, 22′b to the locking element 24. In particular, in the erected position of the wheelchair frame, the left anchoring rod 43a, respectively the right anchoring rod 43b, is positioned rearward with regard to the vertical plane P1. In this configuration, the torque generated by the leaf spring 42 is directed so as to bias the left and right locking pins 27a, 27b to move toward the first left and right abutments 26a, 26b respectively, thus maintaining the wheelchair frame in its erected position. On the contrary, in the folded position of the wheelchair frame, the left anchoring rod 43a, respectively the right anchoring rod 43b, is positioned frontward with regard to said vertical plane P1. In this configuration, the torque generated by the leaf spring 42 is directed so as to bias the left and right locking pins 27a, 27b to move toward the second left and right abutments 26′a, 26′b respectively, thus maintaining the wheelchair frame in its folded position.

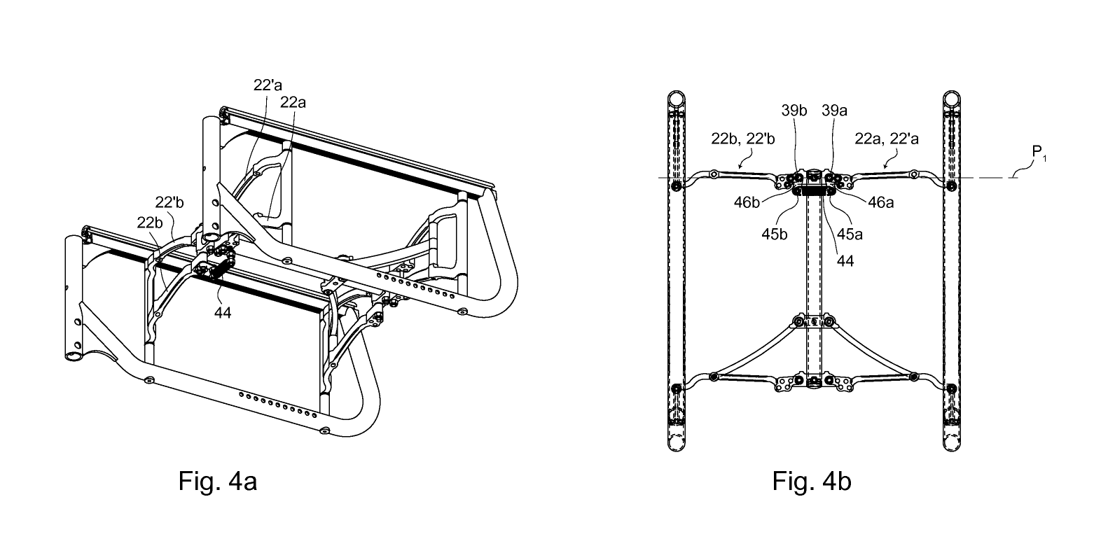

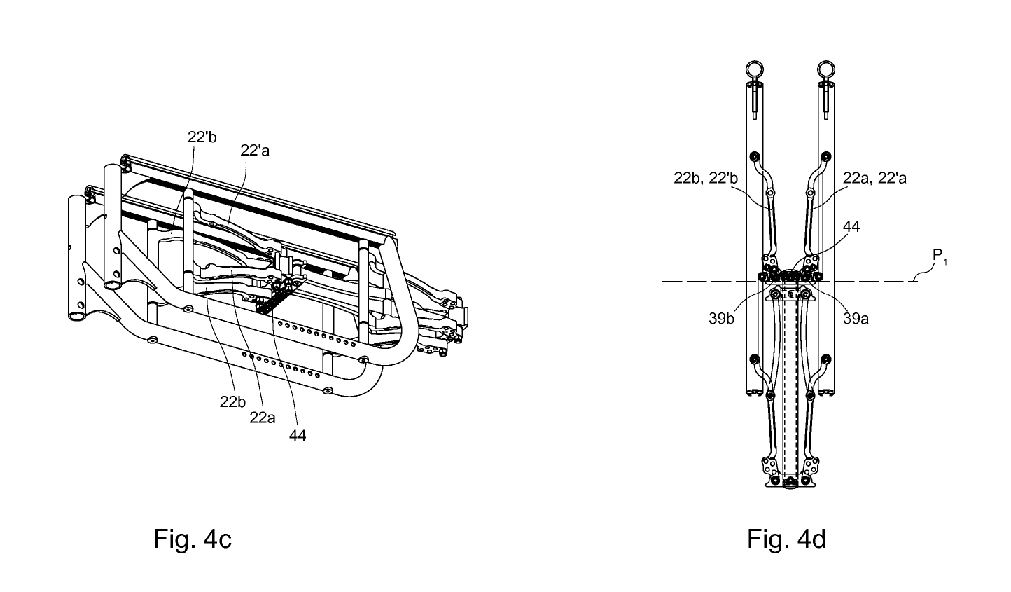

In the embodiment shown illustrated in FIGS. 4a to 4d, the safety means consists in a coil spring 44 attached at one end to a left anchoring rod 45a extending between and fixedly connected to the first lower and upper left connecting arms 22a, 22′a and at the other end to a right anchoring rod 45b fixedly connected to the first lower and upper right connecting arms 22b, 22′b. In the embodiment shown, the left anchoring rod 45a, respectively the right anchoring rod 45b, is received in a through-hole provided at one end of a linking plate 46a, respectively 46b, which is fixedly connected to the first lower and upper left connecting arms 22a, 22′a, respectively the first lower and upper right connecting arms 22b, 22′b, through a screw 46a, respectively 46b, which is received in one of the through-hole 41i and 41j provided in the distal end 41 of the first lower and upper left connecting arms 22a, 22′a, respectively the first lower and upper right connecting arms 22b, 22′b. In the preferred embodiment shown, the left, respectively the right, anchoring rod 45a, respectively 45b, is positioned, in the erected position of the wheelchair frame, rearward with regard to the vertical plane P1 that goes through the pivot axes 39a, 39b around which are pivotally connected said first lower and upper left and right connecting arms 22a, 22′a, 22b, 22′b to the locking element 24, thus biasing the left and right locking pins 27a, 27b to move toward the first left and right abutments 26a, 26b respectively, and, in the folded position of the wheelchair frame, frontward with regard to said vertical plane P1, thus biasing the left and right locking pins 27a, 27b to move toward the second left and right abutments 26′a, 26′b respectively.

In a further embodiment (not shown), the safety means consists in at least one magnet disposed at the periphery of the locking element 24 so as to be in contact with a metallic part of the left and/or the right locking pin 27a, 27b in the erected and/or folded position of the wheelchair frame.

In a further embodiment (not shown), the safety means consists in at least one magnet disposed at the periphery of the left or the right locking pin 27a, 27b so as to be in contact with a metallic part of the locking element 24 in the erected and/or folded position of the wheelchair frame.

The above detailed description with reference to the drawings illustrates rather than limit the invention. There are numerous alternatives, which fall within the scope of the appended claims.

In particular, in a further embodiment (not shown), each wing 22 and 23 illustrated in FIGS. 1, 2a-2e, 3a-3d, 4a-4d may be replaced by a single connecting arm. In this case, the left and the right locking pins 27a, 27b may protrude in a vertical direction from the lower or upper face 28 or 28′ of said connecting arms.

1-37. (canceled)

38. A foldable wheelchair frame comprising two side frame components, respectively a left and a right side frame components, each mounting front and rear wheels, said side frame components being connected together for relative folding movement between an erected position and a folded position by foldable link means extending between said two side frame components, wherein the foldable link means comprises at least one central strut disposed between said two side frame components and connected to each side frame component by at least two connecting arms, respectively a first left and a second left connecting arms connected to the left side frame component and a first right and a second right connecting arms connected to the right side frame component, each of said connecting arms being pivotally connected at one end to one of said side frames and at one other end to said central strut such that said side frame components move closer to each other and said central strut moves along a longitudinal direction when the wheelchair frame moves from its erected position to its folded position, and wherein said central strut comprises at least one locking element, said locking element defining at least one left abutment, respectively one right abutment, against which abuts a left locking pin, respectively a right locking pin, protruding from the lower or upper face of one of said first left and said second left, respectively said first right and said second right, connecting arms in a vertical direction, when the wheelchair frame is in its erected position and wherein the pivot axes around which are pivotally connected the first left and right, respectively the second left and right, connecting arms to the central strut are positioned, in the erected position of the wheelchair frame, frontward relative to the vertical plane going through the pivot axes around which are pivotally connected said connecting arms to the left and right side frame components, thus securing the wheelchair frame in its erected position.

39. The wheelchair frame of claim 38, wherein said at least one central strut is connected to each side frame component by at least two pairs of connecting arms, respectively a first lower and upper left and a second lower and upper left connecting arms connected to the left side frame component and a first lower and upper right and a second lower and upper right connecting arms connected to the right side frame component, each of said connecting arms being pivotally connected at one end to one of said side frames and at one other end to said central strut such that said side frame components move closer to each other and said central strut moves along a longitudinal direction when the wheelchair frame moves from its erected position to its folded position, and wherein said central strut comprises at least one locking element, said locking element defining at least one left abutment, respectively one right abutment, against which abuts a left locking pin, respectively a right locking pin, extending in a vertical direction between said first lower and upper left or between said second lower and upper left, respectively between said first lower and upper right or between said second lower and upper right, connecting arms, when the wheelchair frame is in its erected position and wherein the pivot axes around which are pivotally connected the first left and right, respectively the second left and right, pairs of connecting arms to the central strut are positioned, in the erected position of the wheelchair frame, frontward relative to the vertical plane going through the pivot axes around which are pivotally connected said pairs of connecting arms to the left and right side frame components, thus securing the wheelchair frame in its erected position.

40. The wheelchair frame of claim 38, wherein the locking element defines a first left and a second left abutments, respectively a first right and a second right abutments, against which abuts the left locking pin, respectively the right locking pin, protruding from the lower or upper face of one of said first left and said second left, respectively said first right and said second right, connecting arms in a vertical direction, said first left abutment, respectively said first right abutment, corresponding to the erected position of the wheelchair frame and said second left abutment, respectively said second right abutment, corresponding to the folded position of the wheelchair frame.

41. The wheelchair frame of claim 39, wherein the locking element defines a first left and a second left abutments, respectively a first right and a second right abutments, against which abuts the left locking pin, respectively the right locking pin, extending in a vertical direction between said first lower and upper left or between said second lower and upper left, respectively between said first lower and upper right or between said second lower and upper right, connecting arms, said first left abutment, respectively said first right abutment, corresponding to the erected position of the wheelchair frame and said second left abutment, respectively said second right abutment, corresponding to the folded position of the wheelchair frame.

42. The wheelchair frame of claim 38, wherein each of said connecting arms is articulated around a vertical axle and comprises a proximal part pivotally connected to one of said side frame components and a distal part pivotally connected to said central strut, said proximal part and said distal part being pivotally connected together around said vertical axle.

43. The wheelchair frame of claim 39, wherein each of said connecting arms is articulated around a vertical axle and comprises a proximal part pivotally connected to one of said side frame components and a distal part pivotally connected to said central strut, said proximal part and said distal part being pivotally connected together around said vertical axle, and wherein the proximal parts of the first lower and upper left, and/or, respectively, of the second lower and upper left, and/or, respectively, of the first lower and upper right, and/or, respectively, of the second lower and upper right, connecting arms are linked by a vertical flange so as to form a single U-shape piece, said U-shape piece being pivotally connected to a vertical crosspiece of one of the side frame component.

44. The wheelchair frame of claim 43, wherein the foldable link means comprises at least one left lever arm and one right lever arm, each of said at least one left and right lever arm being pivotally connected at one end to a guiding element slidably movable along the central strut and at the other end to a vertical crossbar extending between the first lower and upper left, or the second lower and upper left, or the first lower and upper right, or the second lower and upper right, connecting arms.

45. The wheelchair frame of claim 44, wherein the vertical crossbar is approximately aligned with the vertical axle around which is pivotally connected the proximal part and the distal part of a connecting arm.

46. The wheelchair frame of claim 40, wherein the locking element comprises a left end portion, respectively a right end portion, said left end portion, respectively said right end portion, having approximately a quarter-cylindrical form, the axis of said quarter-cylindrical form being aligned with the pivot axis around which is pivotally connected one of the connecting arms to the central strut and wherein the first left and the second left abutments, respectively the first right and the second right abutments, of the locking element are defined by two radially protruding parts of said left end portion, respectively said right end portion.

47. The wheelchair frame of claim 38, wherein a distal end of each connecting arm is provided with a plurality of vertical through-holes, said through-holes being adapted to receive the left or right locking pin so that the position of said locking pin can be modified, thus allowing small changes in the configuration of the wheelchair frame in its erected and/or folded position.

48. The wheelchair frame of claim 38, wherein the foldable link means further comprises safety means adapted to maintain the left and/or right locking pin in contact with the corresponding abutments of the locking element, thus maintaining the wheelchair frame in its erected or folded position.

49. The wheelchair frame of claim 48, wherein said safety means is an arc-shaped leaf spring attached at one end to a left anchoring rod fixedly connected to the first left, or the second left, connecting arm or pair of connecting arms and at the other end to a right anchoring rod fixedly connected to the first right, or a second right, connecting arm or pair of connecting arms, said first left and said first right, respectively said second left and said second right, connecting arms or pair of connecting arms being sensitively symmetrical with regard to the vertical plane going through the center of the arc defined by said leaf spring.

50. The wheelchair frame of claim 49, wherein the central strut is aligned with the vertical plane that goes through the center of the arc defined by the leaf spring.

51. The wheelchair frame of claim 49, wherein the leaf spring is configured so that the direction of the torque generated by said leaf spring changes according to the position of the left and right anchoring rods relative to the vertical plane going through the pivot axes around which are pivotally connected the first left and right, respectively the second left and right, connecting arms or pairs of connecting arms to the locking element.

52. The wheelchair frame of claim 51, wherein, when the left anchoring rod, respectively the right anchoring rod, is positioned rearward with regard to the vertical plane, the torque generated by the leaf spring is directed so as to bias the left and right locking pins to move toward the first left and right abutments respectively, thus maintaining the wheelchair frame in its erected position, and, when the left anchoring rod, respectively the right anchoring rod, is positioned frontward with regard to said vertical plane, the torque generated by the leaf spring is directed so as to bias the left and right locking pins to move toward the second left and right abutments respectively, thus maintaining the wheelchair frame in its folded position.

53. The wheelchair frame of claim 48, wherein said safety means is a coil spring attached at one end to a left anchoring rod fixedly connected to the first left, or the second left, connecting arm or pair of connecting arms and at the other end to a right anchoring rod fixedly connected to the first right, or the second right, connecting arm or pair of connecting arms, said left and right anchoring rods being positioned, in the erected position of the wheelchair frame, rearward with regard to the vertical plane going through the pivot axes around which are pivotally connected said first left and right, or said second left and right, connecting arms or pairs of connecting arms to the locking element, thus biasing the left and right locking pins to move toward the first left and right abutments respectively, and, in the folded position of the wheelchair frame, frontward with regard to said vertical plane, thus biasing the left and right locking pins to move toward the second left and right abutments respectively.

54. The wheelchair frame of claim 48, wherein said safety means is at least one magnet disposed at the periphery of the locking element so as to be in contact with a metallic part of the left and/or the right locking pin in the erected and/or folded position of the wheelchair frame.

55. The wheelchair frame of claim 48, wherein said safety means is at least one magnet disposed at the periphery of the left or the right locking pin so as to be in contact with a metallic part of the locking element in the erected and/or folded position of the wheelchair frame.

56. A wheelchair comprising a wheelchair frame according to claim 38.

57. A foldable wheelchair frame comprising two side frame components, respectively a left and a right side frame components, each mounting front and rear wheels, said side frame components being connected together for relative folding movement between an erected position and a folded position by foldable link means extending between said two side frame components, wherein the foldable link means comprises at least one central strut disposed between said two side frame components and connected to each side frame component by at least two connecting arms, respectively a first left and a second left connecting arms connected to the left side frame component and a first right and a second right connecting arms connected to the right side frame component, each of said connecting arms being pivotally connected at one end to one of said side frames and at one other end to said central strut such that said side frame components move closer to each other and said central strut moves along a longitudinal direction when the wheelchair frame moves from its erected position to its folded position, and wherein said central strut comprises at least one locking element, said locking element defining a first left and a second left abutments, respectively a first right and a second right abutments, against which abuts a left locking pin, respectively a right locking pin, protruding from the lower or upper face of one of said first left and said second left, respectively said first right and said second right, connecting arms in a vertical direction, said first left abutment, respectively said first right abutment, corresponding to the erected position of the wheelchair frame and said second left abutment, respectively said second right abutment, corresponding to the folded position of the wheelchair frame.

58. The wheelchair frame of claim 57, wherein said at least one central strut is connected to each side frame component by at least two pairs of connecting arms, respectively a first lower and upper left and a second lower and upper left connecting arms connected to the left side frame component and a first lower and upper right and a second lower and upper right connecting arms connected to the right side frame component, each of said connecting arms being pivotally connected at one end to one of said side frames and at one other end to said central strut such that said side frame components move closer to each other and said central strut moves along a longitudinal direction when the wheelchair frame moves from its erected position to its folded position, and wherein said central strut comprises at least one locking element, said locking element defining a first left and a second left abutments, respectively a first right and a second right abutments, against which abuts a left locking pin, respectively a right locking pin, extending in a vertical direction between said first lower and upper left or between said second lower and upper left, respectively between said first lower and upper right or between said second lower and upper right, connecting arms, said first left abutment, respectively said first right abutment, corresponding to the erected position of the wheelchair frame and said second left abutment, respectively said second right abutment, corresponding to the folded position of the wheelchair frame.

59. The wheelchair frame of claim 57, wherein each of said connecting arms is articulated around a vertical axle and comprises a proximal part pivotally connected to one of said side frame components and a distal part pivotally connected to said central strut, said proximal part and said distal part being pivotally connected together around said vertical axle.

60. The wheelchair frame of claim 59, wherein the proximal parts of the first lower and upper left, and/or, respectively, of the second lower and upper left, and/or, respectively, of the first lower and upper right, and/or, respectively, of the second lower and upper right, connecting arms are linked by a vertical flange so as to form a single U-shape piece, said U-shape piece being pivotally connected to a vertical crosspiece of one of the side frame component.

61. The wheelchair frame of claim 60, wherein the foldable link means comprises at least one left lever arm and one right lever arm, each of said at least one left and right lever arm being pivotally connected at one end to a guiding element slidably movable along the central strut and at the other end to a vertical crossbar extending between the first lower and upper left, or the second lower and upper left, or the first lower and upper right, or the second lower and upper right, connecting arms.

62. The wheelchair frame of claim 61, wherein the vertical crossbar is approximately aligned with the vertical axle around which is pivotally connected the proximal part and the distal part of a connecting arm.

63. The wheelchair frame of claim 57, wherein the locking element comprises a left end portion, respectively a right end portion, said left end portion, respectively said right end portion, having approximately a quarter-cylindrical form, the axis of said quarter-cylindrical form being aligned with the pivot axis around which is pivotally connected one of the connecting arms to the central strut and wherein the first left and the second left abutments, respectively the first right and the second right abutments, of the locking element are defined by two radially protruding parts of said left end portion, respectively said right end portion.

64. The wheelchair frame of claim 57, wherein a distal end of each connecting arm is provided with a plurality of vertical through-holes, said through-holes being adapted to receive the left or right locking pin so that the position of said locking pin can be modified, thus allowing small changes in the configuration of the wheelchair frame in its erected and/or folded position.

65. The wheelchair frame of claim 57, wherein the foldable link means further comprises safety means adapted to maintain the left and/or right locking pin in contact with the corresponding abutments of the locking element, thus maintaining the wheelchair frame in its erected or folded position.

66. The wheelchair frame of claim 65, wherein said safety means is an arc-shaped leaf spring attached at one end to a left anchoring rod fixedly connected to the first left, or the second left, connecting arm or pair of connecting arms and at the other end to a right anchoring rod fixedly connected to the first right, or a second right, connecting arm or pair of connecting arms, said first left and said first right, respectively said second left and said second right, connecting arms or pair of connecting arms being sensitively symmetrical with regard to the vertical plane going through the center of the arc defined by said leaf spring.

67. The wheelchair frame of claim 66, wherein the central strut is aligned with the vertical plane that goes through the center of the arc defined by the leaf spring.

68. The wheelchair frame of claim 66, wherein the leaf spring is configured so that the direction of the torque generated by said leaf spring changes according to the position of the left and right anchoring rods relative to the vertical plane going through the pivot axes around which are pivotally connected the first left and right, respectively the second left and right, connecting arms or pairs of connecting arms to the locking element.

69. The wheelchair frame of claim 68, wherein, when the left anchoring rod, respectively the right anchoring rod, is positioned rearward with regard to the vertical plane, the torque generated by the leaf spring is directed so as to bias the left and right locking pins to move toward the first left and right abutments respectively, thus maintaining the wheelchair frame in its erected position, and, when the left anchoring rod, respectively the right anchoring rod, is positioned frontward with regard to said vertical plane, the torque generated by the leaf spring is directed so as to bias the left and right locking pins to move toward the second left and right abutments respectively, thus maintaining the wheelchair frame in its folded position.

70. The wheelchair frame of claim 65, wherein said safety means is a coil spring attached at one end to a left anchoring rod fixedly connected to the first left, or the second left, connecting arm or pair of connecting arms and at the other end to a right anchoring rod fixedly connected to the first right, or the second right, connecting arm or pair of connecting arms, said left and right anchoring rods being positioned, in the erected position of the wheelchair frame, rearward with regard to the vertical plane going through the pivot axes around which are pivotally connected said first left and right, or said second left and right, connecting arms or pairs of connecting arms to the locking element, thus biasing the left and right locking pins to move toward the first left and right abutments respectively, and, in the folded position of the wheelchair frame, frontward with regard to said vertical plane (P1), thus biasing the left and right locking pins to move toward the second left and right abutments respectively.

71. The wheelchair frame of claim 65, wherein said safety means is at least one magnet disposed at the periphery of the locking element so as to be in contact with a metallic part of the left and/or the right locking pin in the erected and/or folded position of the wheelchair frame.

72. The wheelchair frame of claim 65, wherein said safety means is at least one magnet disposed at the periphery of the left or the right locking pin so as to be in contact with a metallic part of the locking element in the erected and/or folded position of the wheelchair frame.

73. The wheelchair frame of claim 57, wherein the pivot axe around which are pivotally connected the first left and right, respectively the second left and right, connecting arms or pairs of connecting arms to the central strut are positioned, in the erected position of the wheelchair frame, frontward relative to the vertical plane going through the pivot axes around which are pivotally connected said connecting arms or pairs of connecting arms to the left and right side frame components, thus securing the wheelchair frame in its erected position.

74. A wheelchair comprising a wheelchair frame according to claim 57.

75. The wheelchair frame of claim 41, wherein each of said connecting arms is articulated around a vertical axle and comprises a proximal part pivotally connected to one of said side frame components and a distal part pivotally connected to said central strut, said proximal part and said distal part being pivotally connected together around said vertical axle, and wherein the proximal parts of the first lower and upper left, and/or, respectively, of the second lower and upper left, and/or, respectively, of the first lower and upper right, and/or, respectively, of the second lower and upper right, connecting arms are linked by a vertical flange so as to form a single U-shape piece, said U-shape piece being pivotally connected to a vertical crosspiece of one of the side frame component.

76. The wheelchair frame of claim 75, wherein the foldable link means comprises at least one left lever arm and one right lever arm, each of said at least one left and right lever arm being pivotally connected at one end to a guiding element slidably movable along the central strut and at the other end to a vertical crossbar extending between the first lower and upper left, or the second lower and upper left, or the first lower and upper right, or the second lower and upper right, connecting arms.

77. The wheelchair frame of claim 76, wherein the vertical crossbar is approximately aligned with the vertical axle around which is pivotally connected the proximal part and the distal part of a connecting arm.

78. The wheelchair frame of claim 41, wherein the locking element comprises a left end portion, respectively a right end portion, said left end portion, respectively said right end portion, having approximately a quarter-cylindrical form, the axis of said quarter-cylindrical form being aligned with the pivot axis around which is pivotally connected one of the connecting arms to the central strut and wherein the first left and the second left abutments, respectively the first right and the second right abutments, of the locking element are defined by two radially protruding parts of said left end portion, respectively said right end portion.
